(19) United States
(12) Patent Application Publication
(10) Pub. No.: US 2008/0092571 A1
(43) Pub. Date: Apr. 24, 2008

(54) Method and system for regulating the operation of an icemaking machine based to optimize the run time based on variable power rates

(75) Inventors: Matthew W. Allison, Mundelein, IL (US); Daniel A. Jaszkowski, Racine, WI (US)

Correspondence Address: Paul D. Greeley;Ohlandt, Greeley, Ruggiero & Perle, L.L.P., 10th Floor, One Landmark Square, Stamford, CT, 06901-2682, US

(73) Assignee: SCOTSMAN ICE SYSTEMS, LLC.

(21) Appl. No.: 11/975,113

(22) Filed: Oct. 17, 2007

Related U.S. Application Data
(60) Provisional application No. 60/829,907, filed on Oct. 18, 2006.
(60) Provisional application No. 60/829,898, filed on Oct. 18, 2006.

(51) Int. Cl. G05D 29/00

(52) U.S. Cl. 62/157

(57) ABSTRACT

An ice-making machine having an assembly and a controller that controls said assembly to make ice. A sensing device senses a current level of ice in an ice bin that receives the ice made by the assembly. The controller compares the current level to a high set point and a low set point and, based on a current energy rate, controls the assembly to maintain the current level at or near the high set point when said current energy rate is low and at or near the low set point when the current energy rate is high to provide energy efficiency. The controller and sensing device are part of a retrofit assembly that retrofits an existing ice machine with the energy efficient feature.

### RELATED APPLICATION

This application claims the benefit of U.S. Provisional Patent Application No. 60/829,907, filed Oct. 18, 2006, and of U.S. Provisional Patent Application No. 60/829,898, filed Oct. 18, 2006, which are each incorporated herein in their entirety.

### FIELD OF THE INVENTION

The present disclosure relates to a system and method for regulation of the operation of an ice-making machine based on the day of the week, the time of day and the cost or rate of energy that varies with time. The present disclosure also relates to a retrofit method and assemblage for the retrofit of an existing ice-making machine.

### BACKGROUND OF THE INVENTION

Conventional ice-making machines continuously make ice whenever a bin sensor detects that the level of ice in such ice storage bin drops below the full level. Typical sensors are mechanical switch-type sensors, optical sensors or thermostats that trigger when the ice disposed within an ice storage bin reaches the full level.

The problem with conventional ice-making machines is that ice is made anytime during the day or night regardless of the cost of energy required to manufacture such ice. In some locations, the cost of energy fluctuates throughout the day, wherein peak usage hours command the highest energy cost per kilowatt, whereas non-peak usage hours conversely result in the lowest energy cost per kilowatt.

There is a need for the control of ice-making machines in an energy efficient manner.

### SUMMARY OF THE INVENTION

The system and method of the present invention manufactures ice when the cost of energy is at or near its lowest point by monitoring both ice storage bin levels and electricity rates by time of day, thereby substantially reducing the total energy cost for manufacturing of ice throughout the day. The retrofit assembly and method of the present invention adds this capability to an existing ice machine.

An ice-making machine of the present invention includes an assembly that makes ice and a sensing device that senses a current level of ice in an ice bin disposed to receive ice made by the assembly. A controller compares the current level to a high set point and a low set point and, based on a current energy rate and controls the assembly to maintain the current level at or near the high set point when the current energy rate is low and at or near the low set point when the current energy rate is high.

In one embodiment of the ice-making machine of the present invention, the controller further controls the assembly to make ice if the ice level is dropping faster than a predetermined usage rate regardless of the current energy rate.

In another embodiment of the ice-making machine of the present invention, the current energy rate is input to the controller by one of a manual input or an automatic input through a network connection to a source of the current electric rate.

In another embodiment of the ice-making machine of the present invention, the controller is disposed on a board that is attached to a main board that comprises a main controller that controls the assembly. The controller of the attached board controls the main controller to turn the assembly on and off in a manner that maintains the current level at or near the high set point or the low set point.

In another embodiment of the ice-making machine of the present invention, the sensing device is connected to a level control board that is attached to the main board.

A method of the present invention operates an assembly of an ice-making machine to make ice by:

obtaining a current energy rate;

sensing a current level of ice in an ice bin disposed to receive the ice from the assembly;

comparing the current level to a high set point and a low set point;

based on a current energy rate, controlling the assembly to maintain the current level at or near the high set point when the current energy rate is low and at or near the low set point when the current energy rate is high.

In one embodiment of the method of the present invention, the method further comprises controlling the assembly to make ice if the ice level is dropping faster than a predetermined usage rate regardless of the current energy rate.

In another embodiment of the method of the present invention, the current energy rate is obtained by one of a manual input or an automatic input through a network connection to a source of the current energy rate.

A retrofit assembly of the present invention comprises an add on to an existing ice-making machine that comprises a main control board that controls an assembly that makes ice that is stored in an ice bin. The retrofit assembly comprises a sensing device that when installed on the ice-making machine senses a current level of ice in the ice bin and a first board that when installed in the ice-making machine compares the current level to a high set point and a low set point and, based on a current energy rate, controls the assembly to maintain the current level at or near the high set point when the current energy rate is low and at or near the low set point when the current energy rate is high.

In one embodiment of the retrofit assembly of the present invention, a second board is installed in the ice-making machine and interconnected with the sensing device and the first board. The second board receives the current level from the sensing device and provides the current level to the first board.

In one embodiment of the retrofit assembly of the present invention, a communication cable is installed to interconnect the first board and the main control board.

A retrofit method of the present invention retrofits an existing ice-making machine that includes an assembly that makes ice that is stored in an ice bin. The retrofit method comprises:

installing a sensing device to the ice-making machine that senses a current level of ice in the ice bin; and

installing a first board to the ice-making machine that comprises a controller that compares the current level to a high set point and a low set point and, based on a current energy rate, controls the assembly to maintain the current level at or near the high set point when the current energy rate is low and at or near the low set point when the current energy rate is high.

In one embodiment of the retrofit method of the present invention, the first board is connected to a main board of the ice-making machine with a cable.

In another embodiment of the retrofit method of the present invention, installing a second board is installed and connects the second board to the sensing device. The second board comprises circuitry that conditions a sensed signal of the sensing device to provide the current level to the controller.

In another embodiment of the retrofit method of the present invention, at least one of the first and second boards is installed on a main board of the ice-making machine.

The present invention also provides many additional advantages, which shall become apparent as described below.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a front-left side perspective view of an ice-making machine cabinet with an exploded view of a control board mounting bracket and main control board with ice storage bin beneath;

FIG. 2 is a logic flow diagram of a method according to the present disclosure;

FIG. 3 is a schematic representation of the front panel of an advanced feature board controller according to the present disclosure;

FIG. 4 is a partial view of the advance feature board of the ice-making machine of FIG. 1; and

FIG. 5 is a perspective view of the bottom of the ice-making machine and the ice bin of FIG. 1.

### DESCRIPTION OF THE PREFERRED EMBODIMENT

The ice-making machine according to the present disclosure regulates ice making based on time variable electrical power rates.

Some utility companies vary power rates during the day to lower demand during peak use hours. Typical ice-making machines are mounted on or above ice storage bins. When power rates are low, the ice-making machine of the present disclosure runs to fill the storage bin. When power rates are high, the ice-making machine lets the ice level in the bin drop to lower levels and maintains them at the lower levels until power rates drop again. Alternatively, if through monitoring the usage rate of the ice, the ice-making machine determines that at the lower levels the customer will run out of ice, the ice-making machine will make ice regardless of electricity rates.

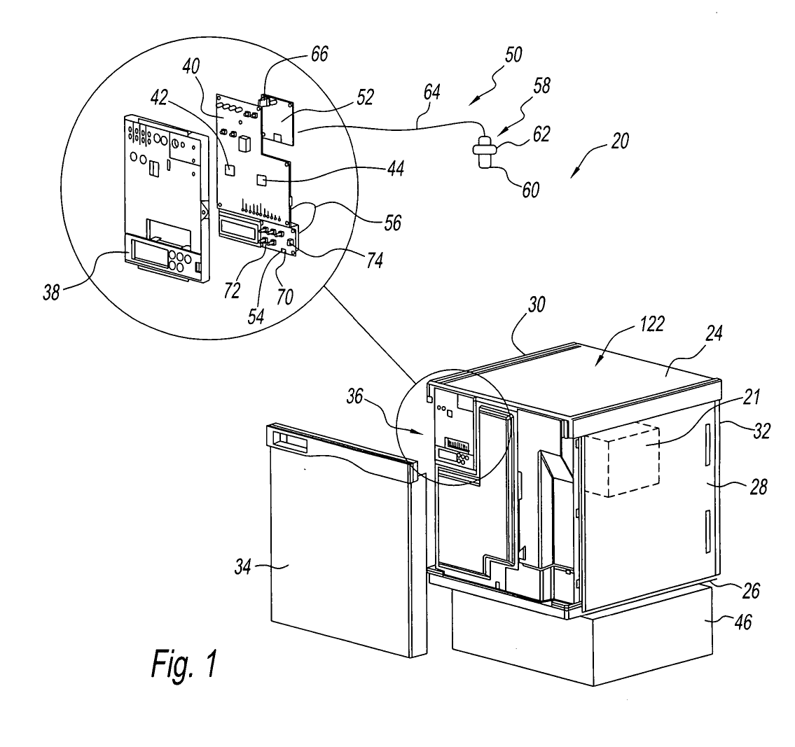

By way of example and completeness of description, the present invention will be described in a preferred embodiment that comprises a field add on or retrofit to an existing ice-making machine. Referring to FIG. 1, an ice-making machine 20 comprises an assembly 21 disposed in a housing 22. Assembly 21 makes ice and includes an evaporator, a condenser, a compressor, a refrigeration circulation system, a water delivery system, various valves and switches (none of which is shown on the drawing). Housing 22 comprises a top wall 24, a bottom wall 26, side walls 28 and 30, a back wall 32 and a front wall 34. In FIG. 1, front wall 34 is detached to show a control board assembly 36. An ice bin 46 is located below bottom wall 26.

Control board assembly 36 comprises a mounting bracket 38 and a main control board 40. A controller 42 and an interface 44 are mounted on main control board 40.

A field add on assembly 50 comprises a bin level control board 52, an advance feature control board 54, a communication cable 56 and a bin level sensing device 58. Bin level sensing device 58 comprises a sensor 60, a mount 62 and a wire 64. Sensor 60 is any suitable sensor that senses a level of ice in ice bin 46. Preferably, sensor 60 is an ultrasonic sensor.

Bin level control board 52 includes circuitry to monitor the current ice level in ice bin 46, a plug (not shown) and a user interface knob 66. Bin level control board 52 plugs into main control board 40. Advance feature control board 54 also plugs into main control board 40 via communication cable 56.

Referring to FIGS. 1, 3 and 4, advance feature control board 54 comprises a processor 70, a user interface 72, a USB port 74, an input/output (I/O) interface 90, a plug 92 and a memory 94. Energy program 100 is stored in memory 94 and when run causes processor 70 to control ice making based on the time of day and energy (e.g., electricity) rates via I/O interface 90 and communication cable 56. That is, I/O interface 90 sends and receives signals to and from main control board 40 and ice level control board 52 via communication cable 56.

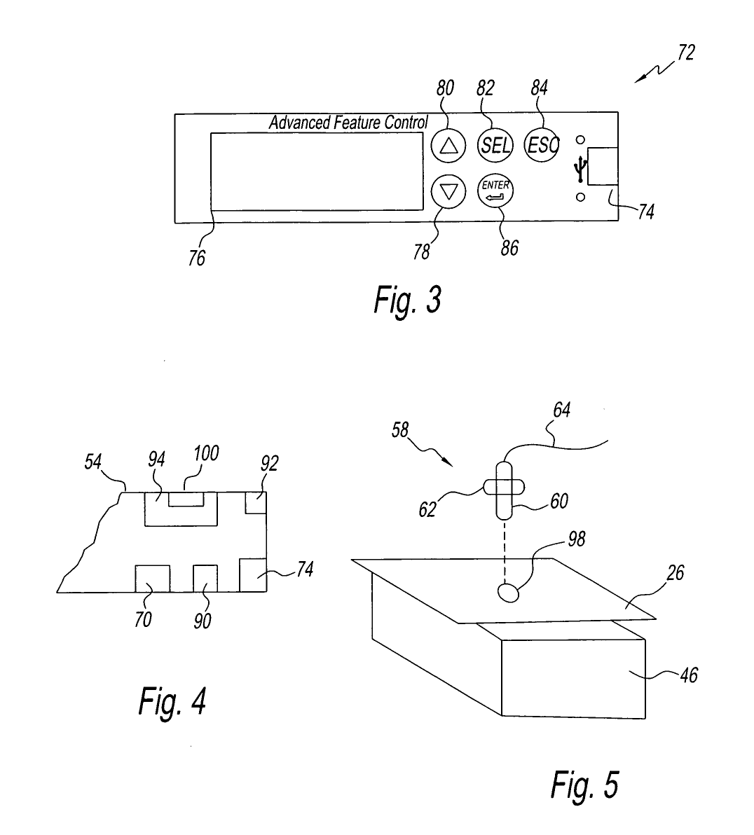

Referring to FIG. 3, user interface 72 comprises USB port 74, a display area 76, a scroll down button 78, a scroll up button 80, a select button 82, an escape button 84 and an enter button 86. The scroll down and up buttons 78 and 80 allow the user to scroll down and up through menu items on a menu presented in display area 76. Select button 82 is used to make changes to settings, such as electricity rates and the times of day when applicable. Enter button 86 changes the menu list to a sub-menu list. Escape button 84 backs up through the menu. The programming can display alerts and data in display area 76. Examples of alerts are “service ice machine soon”, “slow water fill”, “long freeze cycle”, “long harvest cycle”, and “high discharge temperature”.

Ice-making machine 20 operates in the following manner:
1) Advance feature board 54 obtains electric rates and times of day when those electric rates are in effect. This is done via user interface 72 with manual input, a download via USB port 74 or automatic download from a network, such as the Ethernet or Internet. For example, the following keying sequence of the buttons could be used. Press down button 78 until “Utility Rates” is displayed. Press enter button 86. Scroll through adjustable parameters using up and down buttons 80 and 78. To adjust a parameter, press the select button 82. Use up and down buttons 80 and 78 and select button 82 to change values as needed. Press enter button 86 when complete. Adjustable parameters are: Rate 1, Start 1, End 1, Rate 2, Start 2, End 2, Rate 3, Start 3, End 3, Rate 4, Start 4, End 4. If the number of rate increments is less than 4, leave the entries as zero and they will be ignored.
2) If the electric rates are at their lowest level, ice-making machine 20 runs until ice bin 46 is full.
3) If the power rates are not at their lowest, ice-making machine 20 will only run if the current ice level in ice bin 46 sensed by bin level sensing device 58 drops below a predetermined lower level or set point set by the user and will only run until the lower level set point is achieved. In preferred embodiments, the lower level set point can range up to 32 inches below the bottom of the ice machine.
4) If advance feature board 54 determines that the current ice level in ice bin 26 is dropping by more than a predetermined rate, ice-making machine 20 will run to maintain the ice at a level between the user set point and a full point to avoid running out of ice. The predetermined rate is based on a usage factor, for example, in inches per hour, based on ice bin size and machine ice producing capability. The assumption is that the machine starts with a full bin of ice. It then tracks the rate of use as the ice is dropping from the full point to the predetermined lower level cited above. If this rate is too fast, it will start making ice to bring the machine back to the full level. If not too fast, it will let the ice level drop to the predetermined lower level.

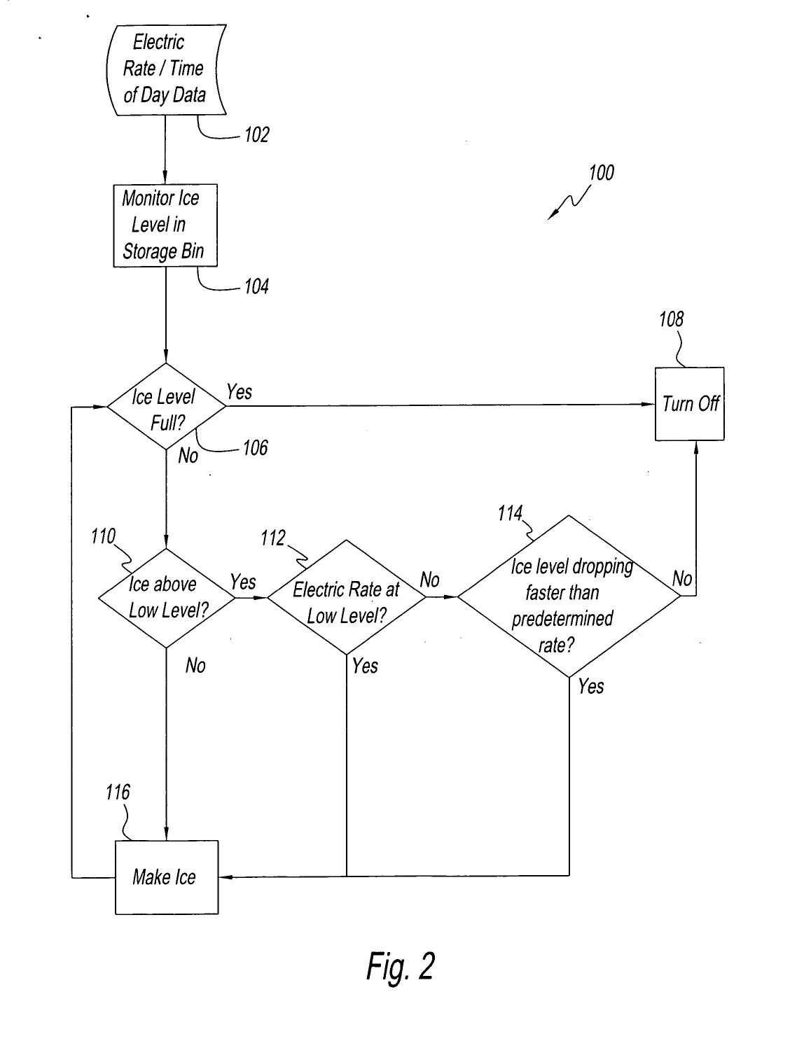

Referring to FIG. 2, energy program 100 further demonstrates the operational relationship among main control board 40, ice level control board 52 and advance feature board 54 to operate ice-making machine 20 in an energy efficient manner according to the present disclosure. A full set point and a low set point are configured in the system. The full set point can be entered manually via knob 66 in ice level control board 52 or via user interface 72 of advance feature control board 54. A full set point entered via advance feature control board 54 overwrites a full set point entered via ice level control board 52. The low set point is entered via user interface 72 of advance feature control board 54.

At step 102 of energy program 100, advance feature control board 54 communicates via USB port 74 with an external energy supplier to determine the respective electric rates and time of day data pertaining to such rates. This electric rate data is stored in memory 94. For example, the electric rate data can be stored in a table with the time of day and an ice level appropriate for that time of day.

At step 104, advance feature board 54 receives a current ice level of ice bin 46 from ice level control board 52 as sensed by ice level sensing device 58. At step 106, it is determined if the current ice level equals the full set point. If the current ice level is at the full set point, then at step 108 advance feature board 54 signals controller 42 to turn ice-making machine 20 off. Steps 106 and 108 may optionally be performed by controller 42. If the current ice level is not full, then at step 110 it is determined if the current ice level is above the low level set point. If the ice level is below the low level set point, advance feature control board 54 at step 116 communicates this determination to controller 42, which continues to operate ice machine 20 to make ice. If the current ice level is above the low level set point, then at step 112 it is determined if the current electric rates are at or below a low electric rate. If the current electric rate is at a low rate, step 116 is performed to signal controller 42 to continue the production of ice, thus taking advantage of the low electric rate. If the current electric rate is above the low level electric rate, then step 114 determines if the ice level is dropping faster than a predetermined rate 32, which is indicative of high usage. If the ice level is dropping faster than the predetermined rate (indicative of high usage), step 116 is performed to signal to controller 42 to continue to make ice. If the ice level is not dropping faster than the predetermined rate (i.e., ice usage is low), step 108 signals controller 42 to turn ice-making machine 20 off.

Referring to FIGS. 1 and 5, field add on or retrofit assembly 50 comprises ice level control board 52, advance feature control board 54, sensing device 58 and communication cable 56. Sensing device 58 is installable in a hole in bottom 26 of ice-making machine 20 such that mount 62 secures sensing device 58 to bottom 26 with sensor 60 projecting downward toward ice bin 46.

An existing ice-making machine is upgraded to the energy efficiency advantage by the installation of retrofit assembly 50. The retrofit method of the present invention retrofits the existing ice-making machine as follows. Sensing device 58 is installed on the housing of ice-making machine 20. Wire 64 is connected to ice level control board 52, for example by a plug. Ice level control board 52 and advance feature board 54 are attached to main control board 40, for example by a plug. Communication cable 56 is connected between advance feature board 54 and main control board 40.

In another embodiment of the ice-making machine, at the time of manufacture sensing device 58 is installed and the functions of ice level control board 52 and advance feature board 54 are incorporated into main control board 40.

The present invention having been thus described with particular reference to the preferred forms thereof, it will be obvious that various changes and modifications may be made therein without departing from the spirit and scope of the present invention as defined in the appended claims.

What is claimed is:

1. An ice-making machine that includes an assembly that makes ice, said ice-making machine comprising:
a sensing device that senses a current level of ice in an ice bin disposed to receive ice made by said assembly;
a controller that compares said current level to a high set point and a low set point and, based on a current energy rate, controls said assembly to maintain said current level at or near said high set point when said current energy rate is low and at or near said low set point when said current energy rate is high.

2. The ice-making machine of claim 1, wherein said controller further controls said assembly to make ice if the ice level is dropping faster than a predetermined usage rate regardless of said current energy rate.

3. The ice-making machine of claim 1, wherein said current energy rate is input to said controller by one of a manual input or an automatic input through a network connection to a source of said current electric rate.

4. The ice-making machine of claim 1, wherein said controller is disposed on a board that is attached to a main board that comprises a main controller that controls said assembly, and wherein said controller controls said main controller to turn said assembly on and off in a manner that maintains said current level at or near said high set point or said low set point.

5. The ice-making machine of claim 1, wherein said sensing device is connected to a level control board that is attached to said main board.

6. A method of operating an assembly of an ice-making machine to make ice, said method comprising:
obtaining a current energy rate;
sensing a current level of ice in an ice bin disposed to receive said ice from said assembly;
comparing said current level to a high set point and a low set point;
based on a current energy rate, controlling said assembly to maintain said current level at or near said high set point when said current energy rate is low and at or near said low set point when said current energy rate is high.

7. The method of claim 6, further comprising controlling said assembly to make ice if the ice level is dropping faster than a predetermined usage rate regardless of said current energy rate.

8. The ice method of claim 6, wherein said current energy rate is obtained by one of a manual input or an automatic input through a network connection to a source of said current energy rate.

9. A retrofit assembly for an existing ice-making machine that comprises a main control board that controls an assembly that makes ice that is stored in an ice bin, said retrofit assembly comprising:
a sensing device that when installed on said ice-making machine senses a current level of ice in said ice bin; and
a first board that when installed in said ice-making machine compares said current level to a high set point and a low set point and, based on a current energy rate, controls said assembly to maintain said current level at or near said high set point when said current energy rate is low and at or near said low set point when said current energy rate is high.

10. The retrofit assembly of claim 9, further comprising a second board that when installed in said ice-making machine is interconnected with said sensing device and said first board, where said second board receives said current level from said sensing device and provides said current level to said first board.

11. The retrofit assembly of claim 9, further comprising a communication cable that when installed interconnects said first board and said main control board.

12. A retrofit method for an existing ice-making machine that includes an assembly that makes ice that is stored in an ice bin, said retrofit method comprising:
installing a sensing device to said ice-making machine that senses a current level of ice in said ice bin; and
installing a first board to said ice-making machine that comprises a controller that compares said current level to a high set point and a low set point and, based on a current energy rate, controls said assembly to maintain said current level at or near said high set point when said current energy rate is low and at or near said low set point when said current energy rate is high.

13. The retrofit method of claim 12, further comprising connecting said first board to a main board of said ice-making machine with a cable.

14. The retrofit method of claim 12, further comprising installing a second board and connecting said second board to said sensing device, and wherein said second board comprises circuitry that conditions a sensed signal of said sensing device to provide said current level to said controller.

15. The method of claim 13, wherein at least one of said first and second boards is installed on a main board of said ice-making machine.
